(19) United States
(12) Patent Application Publication
(10) Pub. No.: US 2012/0064401 A1
(43) Pub. Date: Mar. 15, 2012

(54) TITANIUM SYSTEM COMPOSITE AND THE PREPARING METHOD OF THE SAME

(76) Inventors: Guogang Liu, Shenzhen (CN); Wenfeng Jiang, Shenzhen (CN); Fuzhong Pan, Shenzhen (CN); Yu Xia, Shenzhen (CN); Honggu Pan, Shenzhen (CN)

(21) Appl. No.: 13/321,700

(22) PCT Filed: May 19, 2010
(86) PCT No.: PCT/CN10/72906

§ 371 Date: Nov. 21, 2011

(30) Foreign Application Priority Data
May 27, 2009 (CN) 200910107760.1

(51) Int. Cl. H01M 4/66; H01G 4/008; B32B 18/00; B32B 5/16; H01B 1/00; B32B 9/04

(52) U.S. Cl. 429/209; 252/520.21; 252/519.4; 252/519.2; 252/519.51; 252/520.1; 428/697; 428/328; 361/305

(57) ABSTRACT

The present disclosure discloses a titanium system composite comprising a lithium titanium composite oxide and a lithium compound cladding the lithium titanium composite oxide. The present disclosure further discloses a preparation method of the titanium system composite and an electrode material for batteries or capacitors comprising a titanium system composite.

### CROSS-REFERENCE TO RELATED APPLICATION

This patent application is a §371 national stage patent application based on International Patent Application No. PCT/CN2010/072906, filed May 19, 2010, entitled “TITANIUM SYSTEM COMPOSITE AND THE PREPARING METHOD OF THE SAME”, which claims the priority and benefit of Chinese Patent Application No. 200910107760.1, filed with the State Intellectual Property Office of the P. R. China on May 27, 2009, the entire content of both applications are incorporated herein by reference.

### BACKGROUND

1. Field

The present disclosure generally relates to a titanium system composite and a preparing method of the same.

2. Description of the Related Art

Lithium-ion batteries have been widely used because of their high operating voltage, long cycle life, no memory effect, low self-discharge, and no environmental pollution.

The conventional anode materials for lithium-ion batteries or capacitors in the art are mainly carbon materials such as graphite. But the lithium batteries with a graphite anode have a plurality of disadvantages such as lithium dendrite generation during charging and discharging, which may cause short-circuit of batteries, fire or explosion, and may be react with the electrolyte thus shortening the battery service life.

Lithium titanate can be used as an anode material which has no such safety problems, but it is not widely used because of the following disadvantages: 1) lithium titanate has a high electric potential (1.50 Voltage vs Li), thus causing the electric potential of the battery high; 2) lithium titanate has a poor electrical conductivity, especially during charging and discharging, and thus the battery prepared has a poor high-rate discharge performance; 3) specific capacity of the lithium titanate material is low (with a theoretical value of just 175 milliampere-hours per gram (“mAh/g”)); 4) the consistency and processability of the battery are poor; and 5) the lithium titanate material tends to absorb water, and the prepared battery may be easily inflatable.

### SUMMARY

The present disclosure is directed to solve at least one of the problems exiting in the prior art. Accordingly, a titanium system composite and its preparing method are provided. An embodiment of the present disclosure provides a titanium system composite, which may comprise a lithium titanium composite oxide and a lithium compound cladding the lithium titanium composite oxide.

In one embodiment, the lithium compound may comprise at least one selected from the group consisting of lithium zirconate, lithium vanadate, lithium metasilicate, lithium manganate, lithium carbonate, lithium phosphate, lithium aluminate, lithium hydrogen phosphate, lithium hydroxide, lithium chlorate, lithium sulfate, lithium molybdate, lithium chloride, lithium borate, lithium citrate, lithium tartrate, lithium acetate, and lithium oxalate.

In one embodiment, the lithium titanium composite oxide may be represented by LiₓTi_{y}A_{z}Oₖ, where: A is at least one element selected from the group consisting of Fe, Co, Ni, Mn, Zn, Cu, V, Al, Ca, Mg, Zr, Cr, Sn, Sr or rare earth elements; x, y, z and k satisfy: x+4y+az=2k, in which 0<x≦4, 0<y≦5, 0≦z≦5, 0≦a≦7, 0<k≦12.

Another embodiment of the present disclosure provides a method for preparing a titanium system composite, which may comprise the steps of: a) providing a colloid mixture including a lithium compound and a solvent; b) mixing a lithium titanium composite oxide with the colloid mixture uniformly and then drying to obtain a composition; c) heating the composition under vacuum or an inert gas atmosphere; and d) cooling and grinding the composition to obtain the titanium system composite.

Yet another embodiment of the present disclosure provides an electrode material for batteries or capacitors, which may comprise a titanium system composite including a lithium titanium composite oxide and a lithium compound cladding the lithium titanium composite oxide.

Additional aspects and advantages of the embodiments of present disclosure will be given in part in the following descriptions, become apparent in part from the following descriptions, or be learned from the practice of the embodiments of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

According to an embodiment of the present disclosure, a titanium system composite may comprise a lithium titanium composite oxide and a lithium compound coated on the lithium titanium composite oxide.

The titanium system composite is capable of high-rate charge and discharge in batteries and has more excellent cycle performance and higher safety.

In one embodiment, the lithium compound may be one or more selected from the group consisting of lithium zirconate, lithium vanadate, lithium metasilicate, lithium manganate, lithium carbonate, lithium phosphate, lithium aluminate, lithium hydrogen phosphate, lithium hydroxide, lithium chlorate, lithium sulfate, lithium molybdate, lithium chloride, lithium borate, lithium citrate, lithium tartrate, lithium acetate and lithium oxalate. In one example, the lithium compound may be one or more selected from a group consisting of lithium zirconate, lithium metasilicate, lithium aluminate, lithium hydroxide, lithium chlorate, lithium sulfate, lithium borate, lithium citrate, lithium tartrate, lithium acetate and lithium oxalate.

In some embodiments, the lithium compound may clad the lithium titanium composite oxide compactly so as to form secondary particles. The secondary particle may be spherical or near-spherical particles with an average particle size ranging from about 0.1 microns (“μm”) to about 10 μm.

In some embodiments, base on the total weight of the titanium system composite, the amount of lithium compound may be about 0.5 wt % to about 30 wt %, particularly about 0.5 wt % to about 10 wt %, and the amount of the lithium titanium composite oxide is about 70 wt % to about wt 99.5%, particularly about 90 wt % to about 99.5 wt %, thus improving the cycle performance and high temperature storage performance.

In some embodiments, an average particle size of the lithium titanium composite oxide may be about 0.05 μm to about 10 μm to further improve the high-rate discharge performance. In some embodiments, the lithium titanium composite oxide may be a metal-doped lithium titanate represented by LiₓTi_{y}A_{z}Oₖ, where A is at least one element selected from the group consisting of Fe, Co, Ni, Mn, Zn, Cu, V, Al, Ca, Mg, Zr, Cr, Sn, Sr or rare earth elements; the x, y, z and k satisfy: x+4y+az=2k, in which 0<x≦4, 0<y≦5, 0≦z≦5, 0≦a≦7, 0<k≦12.

Another embodiment of the present disclosure provides a method for preparing a titanium system composite, which may comprise the steps of: a) providing a colloid mixture including a lithium compound and a solvent; b) mixing a lithium titanium composite oxide with the colloid mixture uniformly and then drying to obtain a composition; c) heating the composition under vacuum or an inert gas atmosphere; and d) cooling and grinding the composition to obtain the titanium system composite.

In some embodiments, the solvent may be one or more selected from alcohols, ketones, ethers or water.

In some embodiments, the lithium compound may comprise at least one selected from the group consisting of lithium zirconate, lithium vanadate, lithium metasilicate, lithium manganate, lithium carbonate, lithium phosphate, lithium aluminate, lithium hydrogen phosphate, lithium hydroxide, lithium chlorate, lithium sulfate, lithium molybdate, lithium chloride, lithium borate, lithium citrate, lithium tartrate, lithium acetate, and lithium oxalate.

In other embodiments, the lithium compound may be prepared from a lithium source and a compound source. That to say, the lithium compound can be provided by adding lithium source and compound source into the solvent. In one instance, the lithium source may include one or more members selected from the group consisting of LiCl, LiOH, LiNO₃, CH₃COOLi, Li₂O, and Li₂O₂; and the compound source may include one or more members selected from the group consisting of: metal salts, metal oxides, and nonmetal oxides. In some embodiments, the metal salt may include at least one selected from the group consisting of: acetate, nitrate, halide, phosphate or ammonium salts with at least one metal element selected from Zr, V, Mn, Al and Mo; the metal oxide may have at least one metal element selected from the group consisting of: Zr, V, Mn, Al and Mo; and the nonmetal oxide may have at least one nonmetal element selected from the group consisting of: Si, B and P.

In some embodiments, the molar ratio of Li in the colloid mixture to the Ti in the lithium titanium composite oxide may range from about 0.2:100 to about 165:100. In other embodiments, the molar ratio of the compound source to the lithium source may range from about 5:1 to about 1:2.

In some embodiments, the lithium titanium composite oxide may be represented by LiₓTi_{y}A_{z}Oₖ, where: A is at least one element selected from a group consisting of Fe, Co, Ni, Mn, Zn, Cu, V, Al, Ca, Mg, Zr, Cr, Sn, Sr or rare earth elements; x, y, z and k satisfy: x+4y+az=2k, in which 0<x≦4, 0<y≦5, 0≦z≦5, 0≦a≦7, 0<k≦12.

In some embodiments, the amount of the solvent is not specially limited, and the colloid mixture can be prepared by controlling pH value of the mixture using a variety of acidic, basic or neutral solutions well known in the art. In some embodiments, the pH value of the colloid mixture may be controlled generally as about 3 to 14 with different solutions by, for example, slowly adding proper ammonia while stirring.

In some embodiments, the heating step such as tempering may be performed at a temperature of about 100° C. to about 1000° C., particularly about 300° C. to about 1000° C. for about 0.5 hours to about 48 hours. The heating may comprise a high temperature drying or annealing step depending on the raw materials added, particularly a high temperature annealing step so as to provide a compact cladding layer.

Yet another embodiment of the present disclosure provides an electrode material for batteries or capacitors, which may comprise a titanium system composite including a lithium titanium composite oxide and a lithium compound cladding the lithium titanium composite oxide.

The titanium system composite can be used in batteries or capacitors. In some examples, the titanium system composite is used as an anode active material for a lithium battery, the cathode active material of the lithium battery can be any well-known material in the art such as one or more of LiNiₓCo_{y}Mn_{z}O₂ (0≦x≦1; 0≦y≦1; 0≦z<1), LiFePO₄, LiCoPO₄, LiNiPO₄, Li₃V₂(PO₄)₃ or LiMnPO₄. In some examples, the electrolyte solution for the lithium battery may be any well-known nonaqueous electrolyte solution in the art and may comprise a lithium compound and a non-aqueous solvent. The electrolyte lithium compound may be one or more of various lithium salts in the art including lithium hexafluorophosphate, lithium tetrafluoroborate, lithium hexafluoroarsenate, lithium perchlorate, lithium trifluoromethylsulfonate, lithium perfluorobutane sulfonate, lithium aluminate, lithium chloroaluminate, lithium bis(trifluoromethane sulfonimide), lithium bis(oxalate)borate, lithium chloride and lithium iodide. The non-aqueous solvent may be one or more of various non-aqueous solvents in the art including catenary carbonates, such as methyl ethyl carbonate, methyl propyl carbonate, and dipropyl carbonate; cyclic carbonates, such as γ-butyrolactone; carboxylic esters; cyclic ethers; catenary ethers; anhydrides, amides, such as N,N-dimethylformamide and N-methyl acetamide; and other organic solvents having fluorine, nitrogen and sulfur, such as N-methyl pyrrolidone, acetonitrile, dimethyl sulfoxide, sulfolane, and diethyl sulfite.

The following examples provide additional explanations of the embodiments of the present disclosure.

### Example 1

(1) Preparation of a Titanium System Composite

24.14 grams (“g”) of ZrO₂ and 14.48 g of Li₂CO₃ were added to an ethanol-water mixed solvent with a volume ratio of about 1:1, and stirred for about 1 hour to obtain a mixture. 970 g of a Li₃Ti₃Cr₃O₁₂ lithium titanium composite oxide powder with a particle size D₅₀ of about 1.5 μm was then added to the mixture, and the solution was subsequently heated to about 80° C. and stirred until the mixture was dried.

The dried mixture was baked in an oven at about 800° C. under vacuum for about 24 hours, then cooled to the room temperature, and finally washed and dried to obtain a titanium system composite with a particle size D₅₀ of about 2.0 μm, in which Li₃Ti₃Cr₃O₁₂ was clad with 3% lithium zirconate.

(2) Preparation of an Electrode and a Battery

A mixture containing the titanium system composite, acetylene black, and an adhesive according to a weight ratio of about 85:5:10 was prepared, coated on an aluminum or copper foil, dried at 120° C. in a vacuum oven for about 4 hours, and then pressed to form a negative electrode.

A mixture containing LiFePO₄, acetylene black, and an adhesive NMP according to a weight ratio of about 100:5:5 was prepared, coated on an aluminum foil, dried at 120° C. in a vacuum oven for about 4 hours, and then pressed to form a positive electrode.

The negative electrode and the positive electrode together with a polypropylene or polyethylene separator were wound to form a square battery core, which was placed within a prismatic battery shell. An electrolyte solution 1M LiPF₆ EC/EMC/DMC (with a weight ratio of about 1:1:1) was filled into the shell and sealed in the condition of dryness to provide a lithium-ion battery.

The lithium-ion battery produced was labeled as C1.

### Example 2

(1) Preparation of a Titanium System Composite

23.2 g of Al₂O₃ was added to an acetone-water mixed solvent with a volume ratio of about 1:1, and stirred in a reactor into a uniform slurry, the slurry was heated to about 90° C., about 4.7 g of LiOH.H₂O according to a mole ratio of LiOH.H₂O:Al₂O₃ of about 2:1 was then added to the slurry. After being stirred uniformly and heated at about 100° C. for 2 hours, 970 g of a lithium titanate powder with a particle size D₅₀ of about 1.0 μm was added to obtain, the slurry was subsequently heated to about 80° C. to obtain a mixture and stirred to until the mixture was dried.

The dried mixture was baked in an oven at about 800° C. under an argon atmosphere for about 24 hours, then cooled slowly to the room temperature, and finally washed and dried to obtain a titanium system composite with a particle size D50 of about 1.8 μm, in which Li₃Ti₃Cr₃O₁₂ was clad with 3% lithium aluminate.

(2) Preparation of an Electrode and a Battery

The preparation of the electrode and the battery in Example 2 was substantially similar to that in Example 1, except that the lithium compound was lithium aluminate.

The lithium-ion battery produced was labeled as C2.

### Example 3

(1) Preparation of a Titanium System Composite

30 g of lithium hydroxide was added to an acetone-water mixed solvent with a volume ratio of about 1:1, and then stirred in a reactor into a uniform slurry. After being stirred uniformly and heated to about 60° C. for 2 hours, 970 g of a lithium titanate powder with a particle size D50 of about 2.1 μm was added to the slurry. The slurry was subsequently heated to about 100° C. to obtain a mixture and stirred to until the mixture was dried. The dried mixture was cooled slowly to the room temperature, and washed and dried, and finally ball milled to obtain a titanium system composite with a particle size D50 of about 2.5 μm, in which Li₃Ti₃Cr₃O₁₂ was clad with 3% lithium hydroxide.

(2) Preparation of an Electrode and a Battery

The preparation of the electrode and the battery in Example 3 was substantially similar to that in Example 1, except that the lithium compound was lithium hydroxide.

The lithium-ion battery produced was labeled as C3.

### Example 4

(1) Preparation of a Titanium System Composite

30 g of lithium citrate was added to an acetone-water mixed solvent with a volume ratio of about 1:1, and then stirred in a reactor into a uniform slurry. After being stirred uniformly and heated to about 60° C. for 2 hours, 1000 g of a lithium titanate powder with a particle size D50 of about 3.4 μm was added, the slurry was subsequently heated to about 100° C. to obtain a mixture and stirred to until the mixture was dried. The dried mixture was cooled slowly to the room temperature, and washed and dried, and finally ball milled to obtain a titanium system composite with a particle size D50 of about 4.1 μm, in which Li₃Ti₃Cr₃O₁₂ was clad with 3% lithium citrate.

(2) Preparation of an Electrode and a Battery

The preparation of the electrode and the battery in Example 4 was substantially similar to that in Example 1, except that the lithium compound was lithium citrate.

The lithium-ion battery produced was labeled as C4.

### Example 5

(1) Preparation of a Titanium System Composite

19.45 g of LiOH was added to an acetone-water mixed solvent with a volume ratio of about 1:1, and a CO₂ gas was slowly passed into the mixture until the pH of the solution reached 9.0. After adding 1000 g of a lithium titanate powder with a particle size D50 of about 5.3 μm, the mixture was heated to about 60° C. to obtain a mixture and stirred to until the mixture was dried. The dried mixture was tempered in an oven at about 800° C. under vacuum for about 24 hours, and then cooled slowly to the room temperature, and washed and dried to obtain a titanium system composite with a particle size D50 of about 6.2 μm, in which Li₃Ti₃Cr₃O₁₂ was clad with 3% lithium carbonate.

(2) Preparation of an Electrode and a Battery

The preparation of the electrode and the battery in Example 5 was substantially similar to that in Example 1, except that the lithium compound was lithium carbonate.

The lithium-ion battery produced was labeled as C5.

### Example 6

The steps in Example 6 were substantially similar to those in Example 1 except that: 4.02 g of ZrO₂ and 2.41 g of Li₂CO₃ were used to obtain a titanium system composite with a particle size D50 of about 1.0 μm in, which Li₃Ti₃Cr₃O₁₂ was clad with 0.5% lithium zirconate.

The lithium-ion battery produced was labeled as C6.

### Example 7

The steps in Example 7 were substantially similar to those of Example 1 except that: 72.42 g of ZrO₂ and 43.44 g of Li₂CO₃ were used to obtain a titanium system composite with a particle size D50 of about 3.7 μm, in which Li₃Ti₃Cr₃Oᵢ₂ was clad with 9% lithium zirconate.

The lithium-ion battery produced was labeled as C7.

### Example 8

The steps in Example 8 were substantially similar to those in Example 1 except that: 201.17 g of ZrO₂ and 120.67 g of Li₂CO₃ were used to obtain a titanium system composite with a particle size D50 of about 6.4 μm, in which Li₃Ti₃Cr₃O₁₂ was clad with 25% lithium zirconate.

The lithium-ion battery produced was labeled as C8.

### Comparative Example 1

(1) Preparation of a Titanium System Composite

A titanium system composite was obtained in which Li₃Ti₃Cr₃O₁₂ was clad with 3% carbon.

(2) Preparation of an Electrode and a Battery

The steps of preparation of the electrode and battery were substantially similar to those in Example 1, except that the cladding layer comprised carbon.

The lithium-ion battery produced was labeled as D1.

Test

1. Capacity Test

At 25° C., batteries C1-C8 and D1 were charged at a current of 0.05 C for 4 hours, charged at a current of 0.1 C for 6 hours to a voltage of 2.5 V, charged at a constant voltage of 2.5V to a cut-off current of 10 mA, and discharged at a constant current of 1 C to a cut-off voltage of 1.3 V. After the end of the 0.05 C charge, the thickness and the initial discharge capacity of the batteries were recorded in Table 1.

2. Cycle Performance Test

At 25° C., batteries C1-C8 and D1 were charged and then discharged at a current of 1 C and a voltage of about 1.2-2.8 V. Such a cycle was repeated for 300 times. The capacity of the batteries and the thickness at the middle of the batteries before and after the 300 cycles were recorded, and the capacity retention rate of the batteries were calculated according to the following equation:

Capacity retention rate=(discharge capacity after the 300th cycle/discharge capacity of the first cycle)×100%.

The thickness change rate of the batteries were calculated according to the following equation:

Thickness change rate=(thickness after the 300th cycles/initial thickness−1)×100%.

The results were recorded in Table 1.

3. High Temperature Storage Performance Test

At 25° C., batteries C1-C8 and D1 were charged and then discharged at a current of 1 coulomb (“C”) and a voltage of about 1.2-2.8 voltage (“V”), and the capacity of the batteries and the thickness (millimeters, m) at the middle of the batteries were recorded, and then batteries C1-C8 and D1 were charged to a voltage of 2.8 V. The batteries were stored at 60° C. for 7 days, and the capacity and the thickness of the batteries were recorded again.

The results were shown in Table 1.

TABLE 1

| | | | | | Initial |
|---|---|---|---|---|---|
| | | Discharge | | | Discharge |
| | | Capacity | Thickness | Thickness | Capacity |
| | | Retention | Change | Change | Retention |
| | | Rate at | Rate at | Rate at | Rate at |
| | Initial | 25° C. | 25° C. | 60° C. | 60° C. |
| | Discharge | after 300 | after 300 | after | after |
| | Capacity/ | cycles | cycles | 7 days | 7 days |
| Battery | mAh | (%) | (%) | (%) | (%) |
| C1 | 601 | 99.3 | 8.6 | 10.3 | 97.3 |
| C2 | 605 | 99.2 | 9.0 | 10.9 | 98.0 |
| C3 | 593 | 98.1 | 8.5 | 9.8 | 96.5 |
| C4 | 590 | 97.9 | 8.7 | 9.7 | 97.0 |
| C5 | 575 | 98.9 | 9.5 | 10.0 | 97.5 |
| C6 | 578 | 97.0 | 9.8 | 9.9 | 97.0 |
| C7 | 591 | 99.4 | 8.9 | 10.2 | 96.8 |
| C8 | 582 | 97.9 | 8.0 | 10.0 | 96.0 |
| D1 | 580 | 90.2 | 20.5 | 30.4 | 86.6 |

4. High-Rate Charge and Discharge Performance Test

At 25° C., batteries C1-C8 and D1 were charged at a current of about 0.2 C, 1 C, 5 C, and 10 C and a voltage of about 1.2-2.8 V to about 2.8 V. The charge capacities of the batteries were recorded and the charge capacity rate of the batteries were calculated. The results were shown in Table 2.

At 25° C., batteries C1-C8 and D1 were charged at a current of about 0.02 C and a voltage of about 1.2-2.8 V to about 2.8 V, and then charged at a constant voltage of 2.8 V to a cut-off current of 10 mA, and finally discharged at 0.2 C, 1 C, 5 C, and 10 C to a cut-off voltage of 2.8 V respectively. The discharge capacities of the batteries were recorded and the discharge capacity rate of the batteries were calculated. The results were shown in Table 2.

Charge capacity rate=(charge capacity at different current/0.2 C charge capacity)×100%.

Discharge capacity rate=(discharge capacity at different current/0.2 C discharge capacity)×100%.

TABLE 2

| | charge | charge capacity | charge capacity | charge capacity | discharge | discharge capacity | discharge Capacity | discharge capacity |
|---|---|---|---|---|---|---|---|---|
| | capacity | at 1 C/charge | at 5 C/charge | at 10 C/charge | capacity | at 1 C/discharge | at 5 C/discharge | at 10 C/discharge |
| | at 0.2 C | capacity at | capacity at | capacity at | at 0.2 C | capacity at | capacity at | capacity at |
| Battery | (mAh) | 0.2 C (%) | 0.2 C (%) | 0.2 C (%) | (mAh) | 0.2 C (%) | 0.2 C (%) | 0.2 C (%) |
| C1 | 595 | 95.2 | 75.4 | 60.3 | 590 | 96.8 | 92.5 | 85.6 |
| C2 | 598 | 95.8 | 75.1 | 60.2 | 591 | 96.0 | 92.6 | 84.9 |
| C3 | 590 | 96.0 | 74.6 | 59.6 | 581 | 95.8 | 91.0 | 85.0 |
| C4 | 580 | 94.9 | 73.5 | 58.4 | 578 | 94.9 | 91.5 | 86.0 |
| C5 | 582 | 95.7 | 73.9 | 59.0 | 580 | 95.6 | 90.9 | 85.7 |
| C6 | 576 | 94.5 | 75.8 | 60.5 | 571 | 94.5 | 90.2 | 81.6 |
| C7 | 582 | 96.5 | 74.5 | 58.9 | 581 | 95.7 | 91.7 | 84.9 |
| C8 | 585 | 90.2 | 70.8 | 50.8 | 584 | 91.2 | 90.0 | 82.0 |
| D1 | 575 | 85.6 | 32.0 | 15.8 | 572 | 90.4 | 86.1 | 51.8 |

It can be seen from the results in Tables 1-2 that the batteries C1-C8 have better security and batter high-rate discharge performance than the battery D1.

Although explanatory embodiments have been shown and described, it would be appreciated by those skilled in the art that changes, alternatives, and modifications all falling into the scope of the claims and their equivalents can be made in the embodiments without departing from spirit and principles of the disclosure.

1. A titanium system composite, comprising:
a lithium titanium composite oxide; and
a lithium compound cladding the lithium titanium composite oxide.

2. The titanium system composite according to claim 1, wherein the lithium compound comprises at least one selected from the group consisting of lithium zirconate, lithium vanadate, lithium metasilicate, lithium manganate, lithium carbonate, lithium phosphate, lithium aluminate, lithium hydrogen phosphate, lithium hydroxide, lithium chlorate, lithium sulfate, lithium molybdate, lithium chloride, lithium borate, lithium citrate, lithium tartrate, lithium acetate, and lithium oxalate.

3. The titanium system composite according to claim 2, wherein the lithium compound comprises at least one selected from the group consisting of lithium zirconate, lithium metasilicate, lithium aluminate, lithium hydroxide, lithium chlorate, lithium sulfate, lithium borate, lithium citrate, lithium tartrate, lithium acetate, and lithium oxalate.

4. The titanium system composite according to claim 1, wherein the titanium system composite is substantially spherical particle with an average particle size of about 0.1 μm to about 10 μm.

5. The titanium system composite according to claim 1, wherein based on a total weight of the titanium system composite, an amount of the lithium compound is about 0.5 wt % to about wt 30% and the lithium titanium composite oxide is present in an amount ranging from about 70 wt % to about 99.5 wt %.

6. The titanium system composite according to claim 5, wherein based on the total weight of the titanium system composite, the amount of the lithium compound is about wt 0.5% to about 10 wt % and the lithium titanium composite oxide is present in an amount ranging from about 90 wt % to about 99.5 wt %.

7. (canceled)

8. (canceled)

9. The titanium system composite according to claim 1, wherein an average particle size of the lithium titanium composite oxide is about 0.05 μm to about 10 μm.

10. The titanium system composite according to claim 1, wherein the lithium titanium composite oxide is represented by LiₓTi_{y}A_{z}Oₖ, where: A is at least one element selected from the group consisting of Fe, Co, Ni, Mn, Zn, Cu, V, Al, Ca, Mg, Zr, Cr, Sn, Sr or rare earth elements; x, y, z and k satisfy: x+4y+az=2k, in which 0<x≦4, 0<y≦5, 0≦z≦5, 0≦a≦7, 0<k≦12.

11. A method for preparing a titanium system composite, comprising steps of:
a) providing a colloid mixture including a lithium compound and a solvent;
b) mixing a lithium titanium composite oxide with the colloid mixture uniformly and then drying to obtain a composition;
c) heating the composition under vacuum or an inert gas atmosphere; and
d) cooling and grinding the composition to obtain the titanium system composite.

12. The method according to claim 11, wherein the solvent is at least one selected from the group consisting of alcohols, ketones, ethers, and water.

13. The method according to claim 11, wherein the lithium compound comprises at least one selected from the group consisting of lithium zirconate, lithium vanadate, lithium metasilicate, lithium manganate, lithium carbonate, lithium phosphate, lithium aluminate, lithium hydrogen phosphate, lithium hydroxide, lithium chlorate, lithium sulfate, lithium molybdate, lithium chloride, lithium borate, lithium citrate, lithium tartrate, lithium acetate, and lithium oxalate.

14. The method according to claim 11, wherein the lithium compound is prepared from a lithium source and a compound source, wherein the lithium source includes at least one selected from the group consisting of: LiCl, LiOH, LiNO₃, CH₃COOLi, Li₂O, and Li₂O₂, and the compound source includes at least one selected from the group consisting of: metal sales, metal oxides, and nonmetal oxides.

15. The method according to claim 14, wherein the metal sale includes at least one selected from the group consisting of:
acetate, nitrate, halide, phosphate or ammonium salts with at least one metal element selected from Zr, V, Mn, Al and Mo; the metal oxide has at least one metal element selected from the group consisting of: Zr, V, Mn, Al and Mo; and the nonmetal oxide has at least one nonmetal element selected from the group consisting of: Si, B and P.

16. The method according to claim 11, wherein the lithium titanium composite oxide is represented by LiₓTi_{y}A_{z}Oₖ, where: A is at least one element selected from the group consisting of Fe, Co, Ni, Mn, Zn, Cu, V, Al, Ca, Mg, Zr, Cr, Sn, Sr or rare earth elements; x, y, z and k satisfy: x+4y+az=2k, in which 0<x≦4, 0<y≦5, 0≦z≦5, 0≦a≦7, 0<k≦12.

17. The method according to claim 11, wherein a molar ratio of Li in the colloid mixture to Ti the lithium titanium composite oxide is about 0.2:100 to about 165:100.

18. The method according to claim 11, wherein the heating step is performed at a temperature of about 100° C. to about 1000° C. for about 0.5 hours to about 48 hours.

19. An electrode material for batteries or capacitors, comprising a titanium system composite including a lithium titanium composite oxide and a lithium compound cladding the lithium titanium composite oxide.
